(19) United States
(12) Patent Application Publication
(10) Pub. No.: US 2026/0211362 A1
(43) Pub. Date: Jul. 23, 2026

(54) BELT CONVEYING APPARATUS AND IMAGE FORMING APPARATUS

(71) Applicant: CANON KABUSHIKI KAISHA, Tokyo (JP)

(72) Inventors: TAKAYA YAMAZAKI, Chiba (JP); TORU MIYAZAWA, Chiba (JP); TAKAAKI DOSHIDA, Tokyo (JP); SHUTARO SAITO, Tokyo (JP); MAKOTO MATSUO, Ibaraki (JP)

(21) Appl. No.: 19/426,809

(22) Filed: Dec. 19, 2025

(30) Foreign Application Priority Data
Jan. 22, 2025 (JP) 2025-009226

(51) Int. Cl. G03G 15/00; G01K 1/02; G01K 3/00; G01K 7/22; G03G 15/16; G03G 15/20

(52) U.S. Cl. CPC G03G 15/55; G01K 1/026; G01K 3/005; G01K 7/22; G03G 15/1615; G03G 15/2053; G03G 15/2064; G03G 15/50; G03G 2215/2038

(57) ABSTRACT

A belt conveying apparatus including: a position detecting portion that includes a first light receiving portion and a second light receiving portion each of which outputs an output value corresponding to a received light amount, a light emitting portion configured to emit light toward the first light receiving portion and the second light receiving portion, a first light receiving portion and a second light receiving portion being arranged on a line, the position detecting portion being disposed to contact one end portion of an endless belt; a correcting portion configured to correct meandering of the endless belt in a width direction of the endless belt by changing a tilt angle of a steering roller based on a first output vale output from the first light receiving portion and a second output value output from the second light receiving portion; and a judging portion configured to judge an over-displacement error when the first output value and the second output value exceed a first threshold value, wherein the correcting portion performs a first control when the first output value and the second output value exceed a second threshold value different from the first threshold value and performs a second control different from the first control when any one of the first output value and the second output value is equal to or less than the second threshold value.

### BACKGROUND

### Field of the Technology

This disclosure relates to a belt conveying apparatus used in an image forming apparatus such as a copying machine, a printer apparatus, a facsimile apparatus of electrophotographic system or inkjet recording system, or a multifunctional printer with these functions, and an image forming apparatus in which the belt conveying apparatus is mounted.

### Description of the Related Art

In the conventional image forming apparatus using electrophotographic system or inkjet recording system, a belt conveying apparatus is used that is provided with an endless belt stretched around stretching rollers. The belt is used as a conveying member that bears and conveys a toner image, an ink image, and a recording material on which an image has been formed.

As a conveying member that bears and conveys a toner image, there exists an intermediate transfer belt that bears and conveys a toner image having been transferred from a photosensitive member to transfer the toner image onto a recording material. Further, as a conveying member that bears and conveys a recording material on which an image is formed, there exist a conveying belt that bears and conveys a recording material on which an image is transferred from the photosensitive member and a fixing belt that nips and conveys a recording material in a fixing device to fix an unfixed image to a recording material.

There is generally a problem that a lateral movement (meandering) occurs for a belt stretched around stretching rollers and driven to rotate. When the lateral movement of the belt occurs while the belt is driven to rotate, the conveying position of the belt in the belt width direction (substantially perpendicular to the conveying direction) moves to either end portion sides. When the belt moves to one end portion side too much, the end portion side might contact another member so that the belt or the member is damaged.

In view of the above, the belt lateral movement control is performed for correcting the lateral movement of the belt by detecting a position of a belt end portion in the belt width direction using a sensor portion and by tilting one of the rollers that stretch the belt based on the output of the sensor portion.

As a sensor portion detecting a position of a belt endo portion in the width direction, the Japanese Patent Application Laid-open No. 2012-234063 discloses the configuration in which a ling emitting portion and two light receiving portions are provided and the position of the lateral movement is detected based on output signals of the two light receiving portion that change in response to a position of the lateral movement of the belt. When the belt is in the normal position, PI control is performed that is a stable feedback feedback control using deviation between the target position and the current position. When the belt begins to move laterally in the outside of the normal position, a pull-in control is performed that adjusts the position by a constant control amount irrespective of the deviation. Further, the belt is fully laterally moved, the belt is judged as an over-displacement error so that the rotation of belt is stopped.

### SUMMARY

To accomplish this object, the present disclosure of a belt conveying apparatus comprising:
an endless belt stretched around a plurality of support members;
a steering roller configured to stretch the endless belt;
a position detecting portion that includes a first light receiving portion and a second light receiving portion each of which outputs an output value corresponding to a received light amount, a light emitting portion configured to emit light toward the first light receiving portion and the second light receiving portion, a first light receiving portion and a second light receiving portion being arranged on a line, the position detecting portion being disposed to contact one end portion of the endless belt;
a correcting portion configured to correct meandering of the endless belt in a width direction of the endless belt by changing a tilt angle of the steering roller based on a first output vale output from the first light receiving portion and a second output value output from the second light receiving portion; and
a judging portion configured to judge an over-displacement error when the first output value and the second output value exceed a first threshold value,
wherein the correcting portion performs a first control when the first output value and the second output value exceed a second threshold value different from the first threshold value and performs a second control different from the first control when any one of the first output value and the second output value is equal to or less than the second threshold value.

Features of the present disclosure will become apparent from the following description of exemplary embodiments with reference to the attached drawings.

### BRIEF DESCRIPTION OF THE DRAWINGS

FIG. 1 is a schematic diagram showing a front cross-sectional view of a full color image forming apparatus according to the first embodiment of the present disclosure.

FIG. 2 is a diagram showing the configuration of the fixing device according the first embodiment of the present disclosure.

FIG. 3 is a diagram showing the entire configuration of a sensor portion according to the first embodiment of the present disclosure.

FIG. 4 is a diagram showing a cross-sectional view of the sensor portion indicated in FIG. 3 viewed from below according to the first embodiment of the present disclosure.

FIG. 5 is an enlarged diagram showing a receiving portion of the sensor according to the first embodiment of the present disclosure.

FIG. 6 is a graph showing the relationship between the position of the end portion of the fixing belt in the belt width direction and voltage output of a light receiving portion according to the first embodiment of the present disclosure.

FIG. 7 is a truth table according to the first embodiment of the present disclosure.

FIG. 8 is a flowchart showing a process the CPU performs in the control portion in FIG. 1 according to the first embodiment of the present disclosure.

FIG. 9 is a graph showing the relationship between the position of the end portion of the fixing belt in the belt width direction and voltage output of a light receiving portion according to the second embodiment of the present disclosure.

FIG. 10 is a truth table according to the second embodiment of the present disclosure.

FIG. 11 is a flowchart showing a process the CPU performs in the control portion in FIG. 1 according to the second embodiment of the present disclosure.

FIG. 12 is a diagram showing the entire configuration of the fixing device according the third embodiment of the present disclosure.

### DESCRIPTION OF THE EMBODIMENTS

Hereinafter, with reference to the drawings, embodiments of the present disclosure will be described in detail. The constructive elements in the following embodiments are just examples and the configuration of the apparatus to which the present disclosure is applied and various conditions such as functions, sizes, materials, shapes and relative arrangements described in the following can be appropriately adapted and changed, and are not intended to limit to only ones in the following embodiments.

### First Embodiment

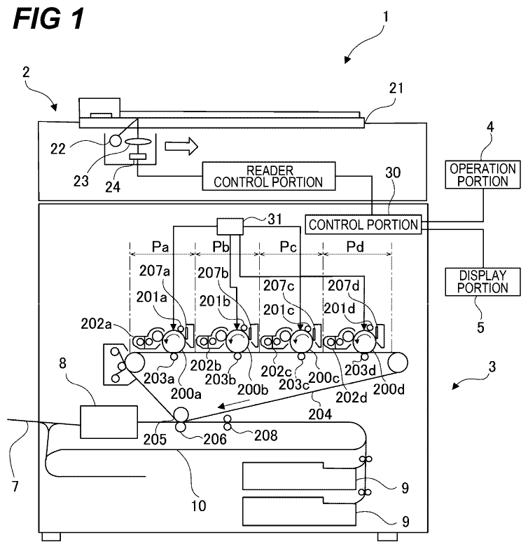

FIG. 1 is a schematic diagram showing a front cross-sectional view of a full color image forming apparatus according to the first embodiment of the present disclosure.

In FIG. 1, the image forming apparatus 1 is a full-color printer of electronic photographic system having four image forming portions Pa, Pb, Pc and Pd as image forming units provided for four colors of yellow, magenta, cyan and black. In the present embodiment, the image forming portions Pa, Pb, Pc and Pd are arranged along the rotation direction of the intermediate transfer belt 204 (described later) as tandem type. The image forming apparatus 1 forms a toner image on a recording material in response to the image signal from an image reading portion (document reading apparatus) 2 connected to the image forming apparatus main body 3 or a host device such as a personal computer communicably connected to the the image forming apparatus main body 3. The recording material is exemplified by a sheet material paper, plastic film, or cloth.

The image forming apparatus 1 is provided with the image reading portion 2 and the image forming apparatus main body 3. The image reading portion 2 reads a document placed on the document base glass 21. The light emitted from the light source 22 is reflected on the document and is focused on the CCD sensor 24 via the optical system member 23 such a lens. This optical system converts the image data of the document into an electric signal data sequence of respective lines by scanning the document in the direction of the arrow. The image signal obtained by the CCD sensor 24 is sent to the image forming apparatus main body 3 where the image processing is performed in conformity with each image forming portion (described later) in the control portion 30. Further the control portion 30 also receives an external input as an image signal from an external host device such as a print server.

The image forming apparatus main body 3 is provided with image forming portions Pa, Pb, Pc and Pd where the image formation is performed based on the above described image signal. Namly, the image signal is converted to a laser beam subjected to PWM (Pulse Width Modulation) control by the control portion 30. The polygon scanner 31 as an exposure device scans with a laser beam corresponding to the image signal. As a result, the photosensitive drums 200a to 200d as image bearing member s of the image forming portions Pa to Pd are irradiated with a laser beam.

The image forming portions Pa, Pb, Pc and Pd form an image of colors yellow (Y), magenta (M), cyan (C) and black (Bk) respectively. The image forming portions Pa, Pb, Pc and Pd have the same configuration as each other and only the configuration of the image forming portion Pa for the color yellow (Y) will be described and description of the configurations of the other image forming portions will be omitted by attaching the same characters b to d to the numbers of the corresponding components.

In the image forming portion Pa, a toner image is formed on the surface of the photosensitive drum 200a based on the image signal as described below.

The charging roller 201a as a primary charging device performs preparation for forming an electrostatic latent image by charging the surface of the photosensitive drum 200a to a predetermined potential. By the laser beam from the polygon scanner 31, an electrostatic latent image is formed on the surface of the photosensitive drum 200a charged to the predetermined potential. The developing device 202a develops the electrostatic latent image on the photosensitive drum 200a to form a toner image. The primary transfer roller 203a applies a primary transfer bias to a polarity opposite to that of the toner by discharging electricity from the back surface of the intermediate transfer belt 204 so that the toner image on the photosensitive drum 200a is transferred to the intermediate transfer belt 204. The surface of the photosensitive drum 200a after the transfer is cleaned by the cleaner 207a.

The toner image for each color on the intermediate transfer belt 204 is conveyed to the next image forming portion and toner images of respective colors are transferred in the order of colors Y, M, C and Bk so that the four color toner image is formed on the surface of the intermediate transfer belt 204. The toner image having passed through the image forming portion Pd for color Bk located at the most lower stream side in the rotation direction of the intermediate transfer belt 204 is conveyed to the secondary transfer portion constituted by the secondary transfer rollers 205 and 206. In the secondary transfer portion, the toner image on the intermediate transfer belt 204 is secondarily transferred to the recording material by applying the secondary transfer potential of polarity opposite that of the toner image on the intermediate transfer belt 204.

The recording materials are accommodated in the cassette 9. A recording material fed from the cassette 9 is conveyed to the registration portion 208 constituted by a pair of registration rollers and stands by at the registration portion 208. The timing of the registration portion 208 is controlled such that the toner image on the intermediate transfer belt 204 becomes in conformity with the position of the recording material and the recording material is conveyed to the secondary transfer portion.

The recording material on which a toner image has been transferred at the secondary transfer portion is conveyed to the fixing device 8 where the recording material is heated and pressed so that the toner image borne on the recording material is fixed to the recording material. The recording material having passed through the fixing device 8 is discharged to the discharge tray 7. In the case where image formation is performed on both surfaces of the recording material, when the transfer and fixation of a toner image on the first surface (front surface) of the recording material is completed, the surfaces of the recording material are reversed via the reverse conveying portion 10, the transfer and fixation of a toner image are performed on the second surface (back surface) of the recording material, and the recording material is stacked on the discharge tray 7.

The control portion 30 controls the entire operation of the image forming apparatus 1 as described above. The control portion 30 can performs various settings based on the inputs from operation portion 4 and the display portion 5 of the image forming apparatus 1. The operation portion 4 and the display portion 5 are provided on the image forming apparatus 1 and are for example a touch panel on which a touch operation is possible and a button.

The control portion 30 has a CPU (Central Processing Unit), a ROM (Read Only Memory) and RAM (Random Access Memory). The CPU controls respective portions while reading out the programs stored in the ROM, which correspond to control procedures. In the RAM, working data and input data are stored. The CPU performs the control based on the programs while referring the data stored in the RAM.

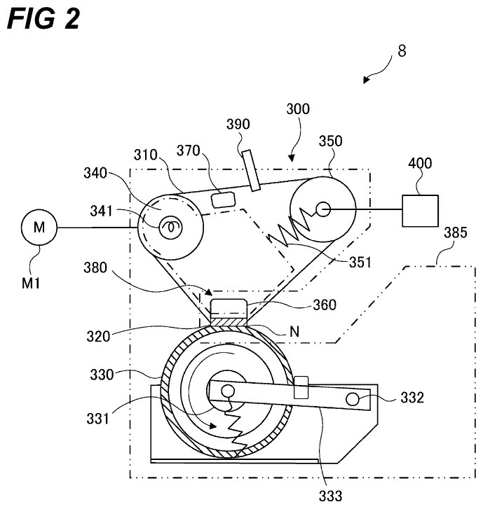

Next, the fixing device 8 to which the belt conveying apparatus of the present embodiment is applied will be described referring to FIG. 2. FIG. 2 is a diagram showing the configuration of the fixing device 8 of FIG. 1.

As shown in FIG. 2, the fixing device 8 of the present embodiment has the belt unit 300 and the pressure roller 330.

The rotation shaft of the pressure roller 330 as a rotating member is axially supported by the frame 385 of the fixing device 8 and is rotated via gears by a driving source (not shown). The pressure roller 330 contacts the outer circumferential surface of the fixing belt 310 of the belt unit 300 with pressure to press the fixing belt 310. Namely, the pressure roller 330 can be moved to a pressing position where the pressure roller 330 contacts and presses the fixing belt 310 and a non-pressing position where the pressure roller 330 is separated from the fixing belt 310 and does not press the fixing belt 310. In order to move the pressure roller 330 to the pressing position and the non-pressing position, the pressure roller 330 is supported by the pressure lever 333 which is axially supported by the rotation shaft 332 and is swung by a pressure motor (not shown).

In the present embodiment, the halogen heater 331 is disposed in the pressure roller 330 and the temperature of the pressure roller is adjusted by the halogen heater 331.

As the pressure roller 330, for example, a roller having a metal rotation shaft and an elastic layer of silicone rubber, fluoro rubber or fluororesin on the outer circumference of the rotation shaft, or a roller further having a releasing layer of fluororesin such as PTFE, PFA and FEP can be used. In the present embodiment, the pressure roller 330 is used that has an elastic layer of silicone rubber with thickness of 300 [μm] and a releasing layer of PFA with 300 [μm].

The belt unit 300 as a belt conveying apparatus is provided with the fixing belt 310 as an endless belt formed endlessly (cylindrically), the heating roller 340, the steering roller 350, the pressing member 380, the sensor portion 390, and the steering mechanism 400. In the present embodiment, the fixing belt 310 is stretched by the heating roller 340 as a first roller, the steering roller 350 as a second roller, and the pressing member 380, which are a plurality of supporting members.

As the fixing belt 310, a resin belt having an elastic layer with high heat conductivity and low heat capacity or a belt with a complex layer structure having a basic layer of a metal belt of stainless steel (SUS) and an elastic layer and a releasing layer on the outer circumference of the basic layer can be used.

In the present embodiment, the fixing belt 310 is used that has a basic layer of SUS, an elastic layer of silicone rubber with the thickness of 250 [μm] and a releasing layer of PFA tube with the thickness of 30 [μm]. It is preferable that a releasing layer is a sheet or a coat layer having a high releasing property and, for example, fluororesin such as PFA and PTFE can be used. A releasing layer can be configured as a multi-layer structure having a basic layer of sheet-like member with high heat resistance such as polyester, polyethylene terephthalate and polyimide amide, a conductive layer on the basic layer and a surface releasing layer on the conductive layer.

The heating roller 340 is, for example, a stainless pipe with the thickness of 1 [mm] and the halogen heater 341 is disposed inside the heating roller 340. The heating roller 340 is driven to rotate via gears by the driving motor M as a driving means. The fixing belt 310 is driven to rotate following the rotation of the heating roller 340. The heating roller 340 is heated by the halogen heater 341 so that the temperature of the fixing belt 310 increases via the heating roller 340. The temperature of the fixing belt 310 is adjusted to a predetermined target temperature in response to the type of the recording material on which an image is formed based on the detection result of the temperature sensor 370 such as a thermistor sensor.

The steering roller 350 presses the fixing belt 310 from the inside towards the outside to stretch the fixing belt 310 with a predetermined tension. In order to do so, the steering roller 350 is urged by the spring 351. In this way, the steering roller 350 has the function to provide a predetermined tension to the fixing belt 310.

Further, in the present embodiment, by tilting the steering roller 350 with a central portion or an end portion being in the rotational axis direction as a swinging fulcrum, the meandering of the fixing belt 310 in the belt width direction (direction crossing the conveying direction of the recording material) is controlled. Namely, the steering roller 350 has the function to adjust the misalignment of the fixing belt 310.

In order to control the misalignment of the fixing belt 310, the sensor portion 390 as a position detecting unit that detects an end portion position of the fixing belt 310 in the belt width direction (detects a deviation position of the fixing belt 310 in the belt width direction) is provided. The steering angle of the steering roller 350 is changed by a steering motor in the steering mechanism 400 as a correction unit for correcting the meandering of the belt in response to the output of the sensor portion 390. The details of the structure and the properties of the sensor portion 390 that detects the position of an end portion of the belt will be detailed later.

The pressing member 380 has the stay 360 and the pressure pad 320. The stay 360 is a rigid member made of metal such as stainless, extending in the width direction of the fixing belt 310 and supports the pressure pad 320 in an attachable manner at the pressure roller 330 side. In the present embodiment, the pressure pad 320 supported by the stay 360 contacts the inner circumference surface of the fixing belt 310 to press the fixing belt 310 from the inner circumferential surface side towards the fixing nip portion N. As a result, the fixing nip portion N is more surely formed for nipping, conveying, pressing and heating the recording material on which a toner image has been formed by cooperating with the heating roller 340. By the pressing pad 320 being supported by stay 360 with high rigidity, the deflection of pressure pad 320 decreases by the pressure of the pressure roller 330 so that uniform nip width can be obtained in the rotation axis direction of the pressure roller 330.

It is preferable that the fixing belt 310 and the pressure pad 320 smoothly slide with each other by a lubricant sheet containing silicone oil or lubricant agent such as silicone oil being intervened between the pressure pad 320 and the fixing belt 310.

The pressure pad 320 is a member made from resin formed as extending in the width direction crossing the rotation direction of the fixing belt 310 along the stay 360. The pressure pad 320 is formed by material with high insulation and high heat resistance such as phenolic resin, polyimide resin, polyamide resin, polyamide-imide resin, PEEK resin, PES resin, PPS resin, PFA resin, PTFE resin, LCP resin, etc.

In FIG. 2, the fixing device 8 having the combination of the fixing belt 310 with an endless belt shape and the pressure roller 330 with a roller shape is illustrated, however, the fixing device is not limited to this. For example, a pressure belt with an endless shape can be used instead of the pressure roller 330. In this case, the pressure belt can be combined with the fixing belt 310 with an endless belt shape, or can be combined with the fixing roller with a roller shape instead of the fixing belt 310. Namely, the fixing device 8 can have the configuration in which the fixing nip portion N is formed with a roller and a belt, or can have the configuration in which the fixing nip portion N is formed with a pair of belts.

Generally, when an endless belt such as the fixing belt 310 is supported and rotated by a plurality of rollers, a meandering phenomenon can occur in which the endless belt in rotation moves in the belt width direction (direction substantially perpendicular to the conveying direction of the endless belt). This occurs by the causes of errors in shapes of an endless belt and rollers that support the endless belt such as deviation of precision of the surface shapes of the rollers and the endless belt in the width direction and circumferential direction, or shifts of the arrangement positions of the rollers. In the case of the fixing device 8 shown in FIG. 2, when the meandering phenomenon occurs for the fixing belt 310, the fixing belt 310 can contact other components so that these components can be damaged like broken. Thus, in the fixing device 8 shown in FIG. 2, it is necessary to suppress the meandering phenomenon for the fixing belt 310.

One of the representative techniques for converging the meandering of an endless belt such as the fixing belt 310 is known as steering system. In the steering system, by swinging one of the rollers that support an endless belt as the steering roller 350 and moving the endless belt in the width direction, the meandering phenomenon for the endless belt is suppressed (corrected). The steering system has advantages of higher reliability and longer life owing to a less force applied to the endless belt as compared with the system in which the meandering of the endless belt is physically suppressed and converged with a rib or a guide.

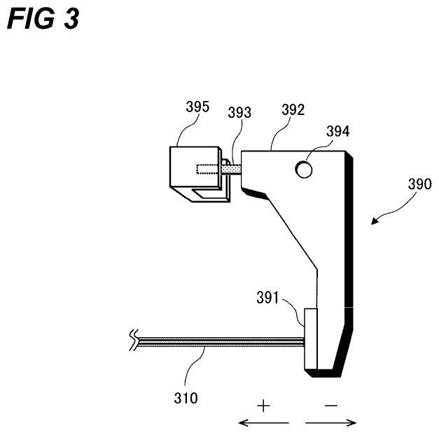

Next, the configuration of the sensor portion 390 that detects the position of the end portion of the fixing belt 310 in the belt width direction will be described with reference to FIG. 3. FIG. 3 is a diagram showing a perspective view of the entire configuration of the sensor portion 390.

As shown in FIG. 3, the sensor portion 390 of the present embodiment is provided with the abutting portion 391 that abuts against the end portion of the fixing belt 310 in the belt width direction, the arm member 392, the light blocking portion 393, the spindle portion 394 and the sensor 395. In this configuration, when the fixing belt 310 laterally moves, the abutting portion 391 and the light blocking portion 393 are swung around the spindle portion 394.

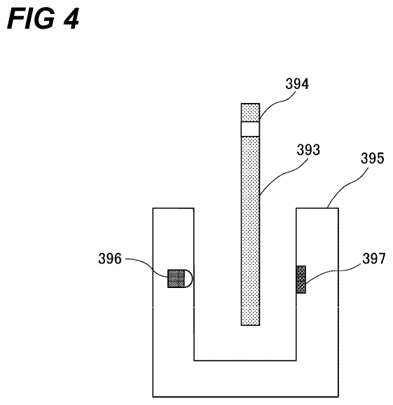

The sensor 395 as a detecting unit is an optical sensor. FIG. 4 is a drawing showing a cross-section of the sensor 395 viewed from below in the FIG. 3. As shown in FIG. 4, the sensor 395 is provided with the light emitting portion 396 and light receiving portion 397. The light blocking portion 393 is located between the light emitting portion 396 and the light receiving portion 397.

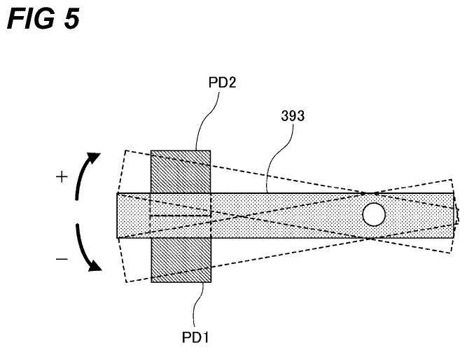

FIG. 5 is a drawing showing an enlarged view of the light receiving portion 397. As shown in FIG. 5, the light receiving portion 397 is divided into two light receiving portion portions PD1 and PD2 as a plurality of light receiving regions for detection. The light receiving portion PD1 as a first light receiving portion and the light receiving portion PD2 as a second light receiving portion are disposed on a line. When the light blocking portion 393 is swung, the region in which the light from the opposing light emitting portion 369 is blocked changes so that the light receiving amounts of the light receiving portions PD1 and PD2 change. The light receiving portions PD1 and PD2 respectively output a voltage (output value) corresponding to the light receiving amount. Thus, when the light receiving amount changes, the output voltage of the sensor 395 changes.

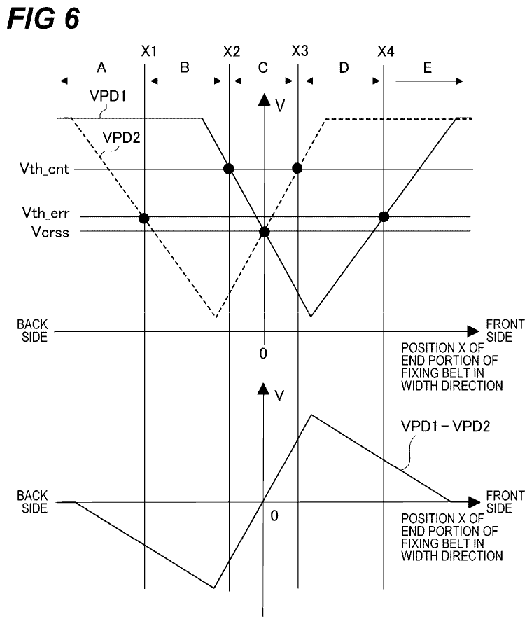

FIG. 6 is a graph showing the relationship between the voltage output VPD1 as a first output value of the light receiving portion PD1 and the voltage output VPD2 as a second output value of the light receiving portion PD2 corresponding to the position of the end portion of the fixing belt 310 in the belt width direction. In FIG. 6, the horizontal axis of the upper graph indicates the position of the end portion of the fixing belt 310 in the belt width direction and the vertical axis indicates the output voltages VPD1 and VPD2. The output voltage VPD1 is shown in a solid line and the output voltage VPD2 is shown in a broken line. The lower graph in FIG. 6 shows the differential operation VPD1-VPD2 of the output voltages VPD1 and VPD2 in the vertical axis.

The position “0” of the end portion of the fixing belt 310 in the belt width direction is a reference position and the output voltage VPD1 is equal to the output voltage VPD2 when the area of the light receiving portion PD1 where the light is blocked by the light blocking portion 393 is equal to the area of the light receiving portion PD2 where the light is blocked by the light blocking portion 393 in FIG. 5. The result of the differential operation VPD1-VPD2 is “0”.

That the position of the end portion of the fixing belt in the belt width direction in the horizontal axis in the graph of FIG. 6 is “+” direction indicates that the fixing belt laterally moves from the reference position towards “+” direction (front side) in FIG. 3 and that the light blocking portion 393 deviates to “+” direction in FIG. 5. When the light blocking portion 393 moves in the “+” direction, the light receiving amount of the light receiving portion PD2 decreases and the light receiving amount of the light receiving portion PD1 increases. As the output voltages VPD1 and VPD2 change in response to the light receiving amount, the output voltage VPD1 of the light receiving portion PD1 increases and the output voltage VPD2 of the light receiving portion PD2 decreases.

That the position of the end portion of the fixing belt in the belt width direction in the horizontal axis in the graph of FIG. 6 is “−” direction indicates that the fixing belt laterally moves from the reference position towards “−” direction (back side) in FIG. 3 and that the light blocking portion 393 deviates to “−” direction in FIG. 5. When the light blocking portion 393 moves in the “−” direction, the light receiving amount of the light receiving portion PD1 decreases and the light receiving amount of the light receiving portion PD2 increases. As the output voltages VPD1 and VPD2 change in response to the light receiving amount, the output voltage VPD1 of the light receiving portion PD1 decreases and the output voltage VPD2 of the light receiving portion PD2 increases.

In FIG. 6, the threshold value for judging an over-displacement error as a first threshold value is denoted by Vth_err (<Vth_cnt), the threshold value for switching between the PI control and the pull-in control as a second threshold value is denoted by Vth_cnt, the voltage where the output voltage VPD1 from the light receiving portion PD1 crosses the output voltage VPD2 from the light receiving portion PD2 (voltage where the magnitudes of the output voltages VPD1 and VPD2 switch with each other) is denoted by Vcrss. In order for the region where the below described VPD1-VPD2 linearly changes to become wide as possible, it is desirable that the Vth_cnt is set as large as possible. Therefore, only the case where Vth_cnt is larger than Vcrss is considered. Further, the present embodiment deals with the case where the threshold value Vth_err for judging an error is larger than Vcrss.

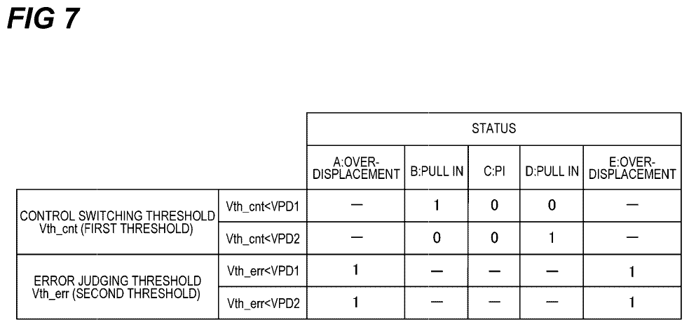

Next, the switching of the control and the judging of the over-displacement error will be described with FIGS. 6, 7 an 8. In the present embodiment, Vth_cnt is used for switching the control and Vth_err is used for judging the over-displacement error are used. These are independently used so that the portions that are not used are indicated by “−” in the truth table of FIG. 7.

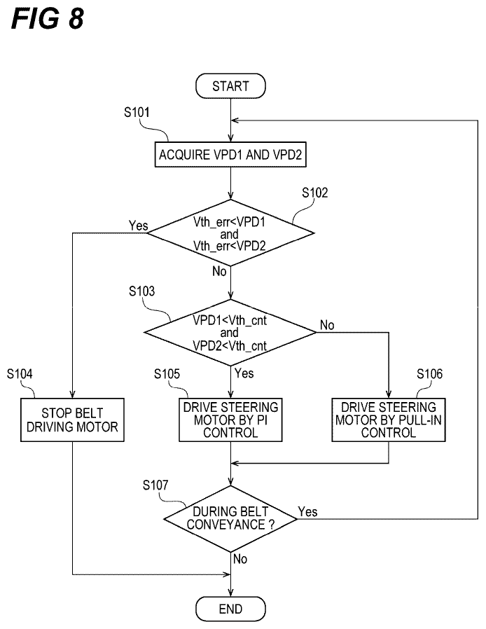

In the region A where the fixing belt 310 is located at the back side of the position X1, Vth_err<VPD1 and Vth_err<VPD2, showing the over-displacement error. The over-displacement error is recognized as a situation where the belt moves over a predetermined position due to the over-displacement and there is a high risk that the end portion of the belt interferes with a member other than the belt. In this situation, the apparatus should be stopped due to the over-displacement error before the belt will be damaged due to the interference. As stated in the step S102 of FIG. 8, the situation where Vth_err<VPD1 and Vth_err<VPD2 is always judged as the over-displacement error. The region A includes a region where Vth_cnt<VPD1 and VPD2<Vth_cnt corresponding to the region B. However, as stated in the step S102, this flowchart prioritizes an error judgement. Therefore, the situation where Vth_cnt(err)<VPD1 and Vth_cnt(err)<VPD2 is always judged as the over-displacement error.

In the region B where the fixing belt 310 is in the range from X1 to X2, Vth_cnt<VPD1 and VPD2<Vth_cnt so that the pull-in control is performed. The pull-in control performs adjustment (correction) by a constant control amount irrespective of the deviation when the belt starts to laterally move. The pull-in control has characteristics of an adjustment force for lateral move being strong and the control is rougher than the PI control and the belt being easier to meander.

In the region C where the fixing belt 310 is in the range from X2 to X3, VPD1<Vth_cnt and VPD2<Vth_cnt so that the PI control is performed. The PI control performs a stable control and is used when the fixing belt 310 is near the normal position in a predetermined section. In the PI control, a feed-back control is performed to correct the lateral movement of the belt by deciding a gain using the proportional relationship from a difference between the target position and the current position. In this region, VPD1-VPD2 as a result of a differential operation shows a linearly increasing property. The lateral move control operation is performed using the result of VPD1-VPD2.

In the region D where the fixing belt 310 is in the range from X3 to X4, VPD1<Vth_cnt and Vth_cnt<VPD2 so that the pull-in control is performed.

In the region E where the fixing belt 310 is located at the front side of X4, Vth_err<VPD1 and Vth_err<VPD2, showing the over-displacement error.

Next, the lateral movement control will be described with reference to the flowchart of FIG. 8. FIG. 8 is a flowchart showing the processes the CPU in the control portion 30 performs of FIG. 1 when the conveyance of the fixing belt 310 is started.

When the conveyance of the fixing belt 310 starts, the output voltages VPD1 and VPD2 of the sensor portion 390 that detects the position of the end portion of the fixing belt 310 in the width direction are converted from analog voltage to digital value and acquired via the A/D port of the CPU in the step S101.

Next, in the step S102, as a judging unit for judging an over-displacement error, an over-displacement error is judged. The output voltages VPD1 and VPD2 of the sensor portion 390 acquired in the step S101 are compared with the threshold value Vth_err for judging the over-displacement of the fixing belt 310 (hereinafter referred to as threshold vale). When both of the output voltages VPD1 and VPD2 are not greater than the threshold value Vth_err, it is not judged as an over-displacement err and the sequence proceeds to the step S103.

When the both of the output voltages VPD1 and VPD2 of the sensor portion 390 are greater than the threshold value Vth_err in the step S102, it is judged as an over-displacement error and the sequence proceeds to the step S104 where the driving motor M1 is stopped to stop the conveyance of the fixing belt 310 so that the process of lateral movement control is completed. When it is judged that belt is not over-displaced in the step S102, the sequence proceeds to the step S103 where the process of changing the control method is performed.

In the step S103, the output voltages VPD1 and VPD2 of the sensor portion 390 acquired in the step S101 are compared with the threshold value Vth_cnt for judging the switching between PI control and pull-in control (hereinafter referred to as control switching threshold value). When both of the output voltages VPD1 and VPD2 are less than the control switching threshold vale Vth_cnt, the sequence proceeds to the step S105 where the steering motor of the steering mechanism 400 is driven such that the amount of tiling of the steering roller 350 by the stable PI control is obtained.

When the one of the output voltages VPD1 and VPD2 of the sensor portion 390 is greater than the control switching threshold Vth_cnt in the step S103, the sequence proceeds to the step S106 where the steering motor of the steering mechanism 400 is driven such that the amount of tiling of the steering roller 350 by the pull-in control is obtained.

In the step S107, it is confirmed whether the belt conveyance is kept or not. When the belt conveyance is kept, the sequence returns to the step S101. When the belt conveyance is stopped, the process of lateral movement control is terminated.

As described above, by performing the switching of control and the over-displacement error judgement are independently performed and by performing the over-displacement error judgement early, the risk can be reduced that the fixing belt 310 interferes with components around the fixing belt 310 to damage the expensive fixing belt 310 and components around the fixing belt 310. With the above configuration, a problem in the prior art can be resolved. Specifically, the voltage levels of the output signals of two light receiving portion are compared with the predetermined threshold value to judge the switching of the PI control and the pull-in control and the over-displacement error. Namely, the threshold value for judging the switching between PI control and pull-in control is the same as the threshold value for judging an over-displacement error of the fixing belt 310. Therefore, there is a problem that in order to judge an over-displacement error early, it is necessary to decrease the threshold level for judging an over-displacement error, leading to a decrease in the threshold level for switching the control of the fixing belt 310 from PI control to the pull-in control, so that the period in which the stable PI control is performed becomes shorter. In the present embodiment, the over-displacement error can early be judged in order to suppress the risk of the expensive fixing belt 310 and the surrounding components being damaged due to the interference of the fixing belt 310 with the surrounding components while keeping the period for stable control in the belt lateral move control.

### Second Embodiment

Next, the second embodiment of the present disclosure will be described.

In the first embodiment, the threshold value for judging an over-displacement error is greater than the Vcrss where the output voltage VPD1 of the receiving portion crosses the output voltage VPD2 of the receiving portion. In the present embodiment, the threshold value for judging an over-displacement error is less than the Vcrss where the output voltage VPD1 of the receiving portion crosses the output voltage VPD2 of the receiving portion (Vth_err<Vcrss<Vth_cnt).

The basic configuration and the operation of the present embodiment is the same as those of the first embodiment that should be referred to and the duplicate description will be omitted.

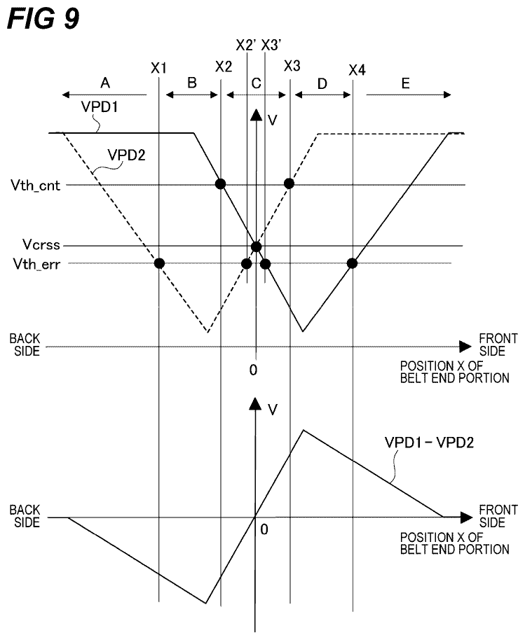

FIG. 9 is a graph showing the relationship between the voltage output VPD1 and the voltage output VPD2 corresponding to the position of the end portion of the fixing belt in the belt width direction in the present embodiment. In FIG. 9, the horizontal axis of the upper graph indicates the position of the end portion of the fixing belt 310 in the belt width direction and the vertical axis indicates the output voltages VPD1 and VPD2. The output voltage VPD1 is shown in a solid line and the output voltage VPD2 is shown in a broken line. The lower graph in FIG. 9 shows the differential operation VPD1-VPD2 of the output voltages VPD1 and VPD2 in the vertical axis.

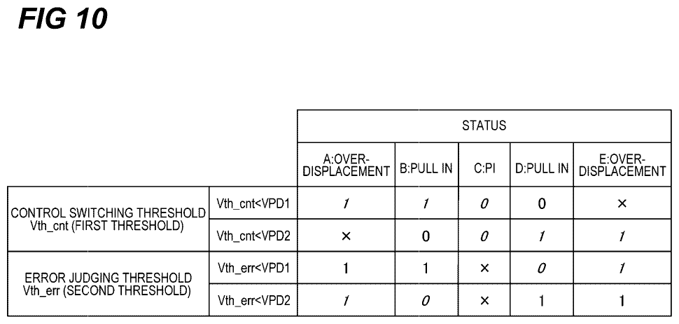

Next, the switching of the control and the judging of the over-displacement error will be described with FIG. 9 an 10. In the truth table of FIG. 10, the portion written in italics is used for the judgement. In the truth table of FIG. 10, the mark “x” means the meeting of the condition in both situations. In the present embodiment, Vth_err<Vcrss. Therefore, when trying to judge an over-displacement error using only the over-displacement threshold value Vth_err similar to the first embodiment (Vth_err<VPD1 and Vth_err<VPD2), the regions X2′ to X3′ in which PI control is desired meet this condition to be judged as an over-displacement error. Thus, both of the over-displacement error threshold Vth_err and control switching threshold value Vth_cnt are used for the judgement of an over-displacement error.

In the region A where the fixing belt 310 is located at the back side of the position X1, Vth_cnt<VPD1 and Vth_err<VPD2, showing the over-displacement error.

In the region B where the fixing belt 310 is in the range from X1 to X2, Vth_cnt<VPD1 and VPD2<Vth_err so that the pull-in control is performed.

In the region C where the fixing belt 310 is in the range from X2 to X3, VPD1<Vth_cnt and VPD2<Vth_cnt so that the PI control is performed.

In the region D where the fixing belt 310 is in the range from X3 to X4, VPD1<Vth_err and Vth_cnt<VPD2 so that the pull-in control is performed.

In the region E where the fixing belt 310 is located at the front side of X4, Vth_err<VPD1 and Vth_cnt<VPD2, showing the over-displacement error.

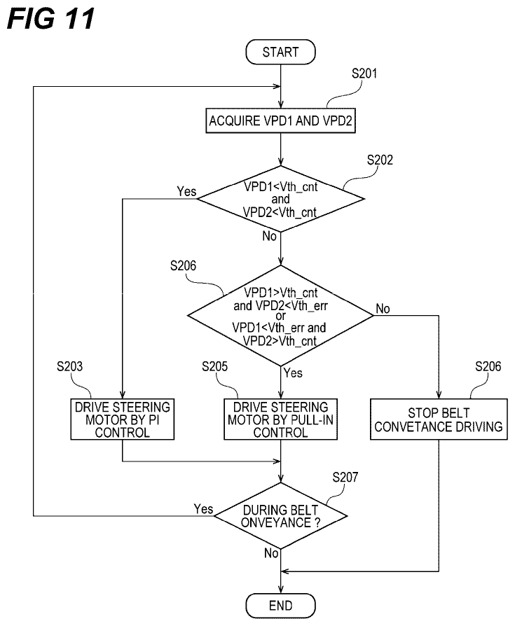

Next, the lateral movement control will be described with reference to the flowchart of FIG. 11. FIG. 11 is the flowchart showing the processes the CPU performs in the control portion 30 of FIG. 1 when the conveyance of the fixing belt 310 is started.

When the conveyance of the fixing belt 310 starts, the output voltages VPD1 and VPD2 of the sensor portion 390 that detects the position of the end portion of the fixing belt 310 in the width direction are converted from analog voltage to digital value and acquired via the A/D port of the CPU in the step S201.

Next, in the step S202, it is judged whether the control is switched to the PI control or not. The output voltages VPD1 and VPD2 of the sensor portion 390 acquired in the step S201 are compared with the control switching threshold value Vth_cnt. When both of the output voltages VPD1 and VPD2 are less than the control switching threshold value Vth_cnt, the sequence proceeds to the step S203 where the steering motor of the steering mechanism 400 is driven such that the amount of tiling of the steering roller 350 by the stable PI control is obtained.

When the above condition to enter the PI control is not satisfied in the step S202, the sequence proceeds to the step S204. When the condition to enter the pull-in control, namely, the output voltage VPD1 is greater than the threshold value Vth_cnt and the output voltage VPD2 is less than the threshold value Vth_err or the output voltage VPD1 is less than the threshold value Vth_err and the output voltage VPD2 is greater than the threshold value Vth_cnt is satisfied in the step S204, the sequence proceeds to the step S205 where the steering motor of the steering mechanism 400 is driven such that the amount of tiling of the steering roller 350 by the pull-in control is obtained.

When the above condition to enter the pull-in control is not satisfied in the step S204, it it is judged as an over-placement error and the sequence proceeds to the step S206 where the driving motor M1 is stopped to stop the conveyance of the fixing belt 310 so that the process of lateral movement control is terminated.

In the step S207, it is confirmed whether the belt conveyance is kept or not. When the belt conveyance is kept, the sequence returned to the step S201. When the belt conveyance is stopped, the process of lateral movement control is terminated.

As described above, in the second embodiment, when the threshold value for judging an over-displacement error is less than the Vcrss where the output voltage VPD1 of the receiving portion crosses the output voltage VPD2 of the receiving portion (Vth_err<Vcrss<Vth_cnt), both of the control switching threshold value Vth_cnt and the over-displacement threshold value Vth_err are used for judging an over-displacement error. With this configuration, the judgement of an over-displacement error can be judged early.

### Third Embodiment

Next, the third embodiment of the present disclosure will be described.

In the first and second embodiments, the single sensor portion 390 is provided that detects the end portion of the fixing belt in the belt with direction. In the present embodiment of the fixing device having the fixing belts at upper and lower positions respectively, the sensor portions 390 are provided that detect the end portions of the fixing belts at the upper and lower positions in the belt with direction.

Further, the basic configuration and operation of the present embodiment is the same as those of the first embodiment that should be referred to and the duplicate description will be omitted.

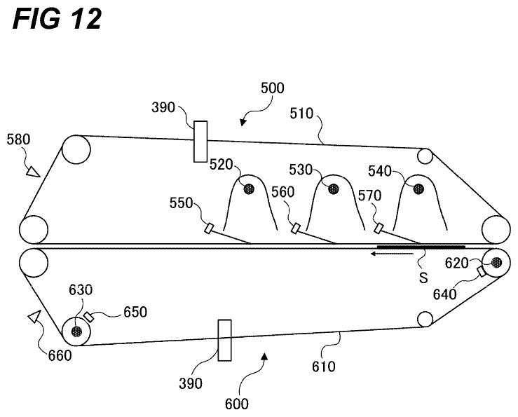

FIG. 12 is a drawing showing the entire configuration of the fixing device in the inkjet recording apparatus including the upper fixing belt system 500 and the lower fixing belt system 600. The inkjet recording apparatus forms an inkjet image on a recording material and fixes the inkjet image by drying the inkjet image. The upper fixing belt system 500 and the lower fixing belt system 600 constitute a fixing system in which a recording material on which an image is formed is conveyed between the upper belt 510 and lower belt 610 that are heated endless belts.

In FIG. 12, the upper belt 510 and the lower belt 610 are driven to rotate by driven motors (not shown) respectively, so that the recording material S is conveyed in the direction of the arrow. In the inkjet recording apparatus, ink is applied to the upper surface of the recording material that is nipped by the upper belt 510. Therefore, the heaters 520, 530 and 540 to melt the ink are provided at the upper belt 510 side. Further, the heaters 620 and 630 are provided at the lower belt 610 side to heat the recording material itself on which ink is applied. The recording material is nipped by the upper belt 510 and the lower belt 610 for a long time while being heated, so that the ink applied on the recording material S permeates into the recording material. As a result, a high print quality can be realized.

The upper fixing belt system 500 is constituted by the heaters 520, 530 and 540, the temperature sensors 550, 560 and 570, and the temperature sensor 580 that adjusts the temperature of the upper belt 510.

The heaters 520, 530 and 540 are covered by reflectors and heat the belt 510 immediately under the heaters 520, 530 and 540.

The temperature sensors 550, 560 and 570 are provided for a safety reason and detect the temperature of the belt area of the heaters 520, 530 and 540 at the upper belt 510 side and watches whether the temperature exceeds 150° C. that is set for the upper belt not to be deformed and is determined in response to the material of the upper belt. Therefore, another value of the temperature can be set in response to the material of the upper belt.

The temperature sensor 580 detects the temperature of the upper belt 510 and is provided for adjusting the temperature of the heaters 520, 530 and 540. The temperature sensor 580 that adjusts the temperature of the upper belt 510 is positioned more downstream of the upper belt 510 than the heaters 520, 530 and 540 and adjusts the temperature of the upper belt 510 to 100° C. to realize a high print quality. 100° C. is set for the ink to be fixed to the recording material and is determined in response to the material of the ink. Therefore, another value of the temperature can be set in response to the material of the ink.

When the heaters 520, 530 and 540 run away, it takes a long time to stop the runaway with the temperature sensor 580 configured to adjust the temperature of the heaters 520, 530 and 540. Thus, the runaway of the heaters 520, 530 and 540 is immediately stopped by the temperature sensors 550, 560 and 570 detecting the temperature immediately under the heaters when the heaters 520, 530 and 540 run away.

As described above, by providing sensors of two types, even if the long nip configuration is adopted, the temperature of the upper belt 510 is precisely adjusted to a predetermined temperature, further even if the heaters 520, 530 and 540 are out of control, the heaters 520, 530 and 540 can be stopped without the belt being deformed.

In order to control the meandering of the upper belt 510 by the steering mechanism 400, the sensor portion 390 that detects the position of the end portion of the upper belt 510 in the belt width direction is provided at the position of the end portion at the front side of the upper belt 510 in the belt width direction.

The lower fixing belt system 600 is constituted by the heaters 620 and 630, the temperature sensors 640 and 650 that detect the surface temperature of the rollers heated by the heaters 620 and 630, and the temperature sensor 660 that detects the temperature of the lower belt 610.

The heaters 620 and 630 are disposed in the rollers and heat the belt via the rollers.

The temperature sensors 640 and 650 are provided for a safety reason and detect the surface temperature of the rollers of the heaters 620 and 630 and stop the the heaters 620 and 630 if the surface temperature is or exceeds 150° C. that is set for the lower belt 610 not to be deformed and is determined in response to the material of the lower belt 610. Therefore, another value of the temperature can be set in response to the material of the lower belt.

The temperature sensor 660 is for adjusting the temperature of the lower belt 610. The temperature of the lower belt 610 is adjusted by controlling the heaters 620 and 630 in response to the temperature of the temperature sensor 660.

In order to control the meandering of the lower belt 610 by the steering mechanism 400, the sensor portion 390 that detects the position of the end portion of the lower belt 610 in the belt width direction is provided at the position of the end portion at the back side of the lower belt 610 in the belt width direction.

In the above embodiments, the control of the lateral movement of the fixing belt is described. However, the present disclosure can be applied to the control of the lateral movement of an intermediate transfer belt or a recording material conveying belt as well.

In the above embodiments, as the senor 395, an optical sensor having two light receiving portions is taken up as an example. However, even when an optical sensor having three or more light receiving portions or a PSD (Position Sensitive Detector) is used, the control can be similarly stabilized by comparing a plurality of output voltages with a plurality of threshold values.

According to the present disclosure, a belt conveying apparatus and an image forming apparatus with the belt conveying apparatus can be provided that can perform an early judgement of an over-displacement error to ensure the period of stable control of the lateral movement of the belt and to suppress the risk that the belt interferes with nearby components and the expensive belt or the nearby components are damaged.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of Japanese Patent Application No.2025-9226, filed Jan. 22, 2025, which is hereby incorporated by reference herein in its entirety.

What is claimed is:

1. A belt conveying apparatus comprising:
an endless belt stretched around a plurality of support members;
a steering roller configured to stretch the endless belt;
a position detecting portion that includes a first light receiving portion and a second light receiving portion each of which outputs an output value corresponding to a received light amount, a light emitting portion configured to emit light toward the first light receiving portion and the second light receiving portion, a first light receiving portion and a second light receiving portion being arranged on a line, the position detecting portion being disposed to contact one end portion of the endless belt;
a correcting portion configured to correct meandering of the endless belt in a width direction of the endless belt by changing a tilt angle of the steering roller based on a first output vale output from the first light receiving portion and a second output value output from the second light receiving portion; and
a judging portion configured to judge an over-displacement error when the first output value and the second output value exceed a first threshold value,
wherein the correcting portion performs a first control when the first output value and the second output value exceed a second threshold value different from the first threshold value and performs a second control different from the first control when any one of the first output value and the second output value is equal to or less than the second threshold value.

2. The belt conveying apparatus according to claim 1,
wherein positions of the endless belt detected by the position detecting portion include a reference position, a first position where the first control and the second control are switched, and a second position where the over-displacement error is judged, and
wherein a distance between the reference position and the second position is greater than a distance between the reference position and the first position.

3. The belt conveying apparatus according to claim 1,
wherein the first control is a feedback control in response to a deviation of a displacement in the width direction of the endless belt and the second control is a control whose correcting force is stronger than that of the first control.

4. The belt conveying apparatus according to claim 1,
wherein the first control is a feedback control in response to a deviation of a displacement in the width direction of the endless belt and the second control is a control in which a correction is performed by a constant control amount with a correcting force stronger than that of the first control.

5. The belt conveying apparatus according to claim 1,
wherein the position detecting portion outputs a plurality of output signals that change in response to a displacement of the endless belt in the width direction of the endless belt.

6. The belt conveying apparatus according to claim 1,
wherein when the judging portion judges the over-displacement error, the endless belt is stopped.

7. The belt conveying apparatus according to claim 1,
wherein the endless belt is a fixing belt of a fixing device configured to fix an image to a recording material.

8. The belt conveying apparatus according to claim 1,
wherein the endless belt is an intermediate transfer belt for transferring an image onto a recording material.

9. An image forming apparatus comprising:
an image forming portion configured to form an image; and
a belt conveying apparatus according to claim 1.
